(19) United States
(12) Patent Application Publication
(10) Pub. No.: US 2009/0211431 A1
(43) Pub. Date: Aug. 27, 2009

(54) AUTOMATIC GUITAR TUNING CASE

(76) Inventor: Zhenxiang Zhang, St. Catharines (CA)

Correspondence Address: ZHENXIANG ZHANG, 41 RYKERT ST., UNIT #108, ST. CATHARINES, ON, L2S3A4, CA

(21) Appl. No.: 12/036,205

(22) Filed: Feb. 22, 2008

(51) Int. Cl. G10G 7/02

(52) U.S. Cl. 84/454

(57) ABSTRACT

An automatic guitar tuning case is a tuning system to automatically, synchronously, accurately and rapidly turn a guitar. To automatically tune one string is not new, but automatically and synchronously tune an acoustic guitar or electrical guitar without modifying the guitar has never be done before. Changing one string's tension will cause all other strings' tension change, so all strings should be tuned synchronously and ended tuning together only when all strings are in tone at the same time. As a closed-loop control system, the automatic guitar tuning case comprises six transducers sensing the vibration frequency of six guitar strings respectively, six tuner units to analyze tones, and a center processor unit to control six electric tuning wrenches to tune the six guitar strings. The automatic guitar tuning case also consists of a control panel for a user to preset and select tuning patterns, control and monitor the system. To tune a guitar with this invention just need to put a guitar in the case and close the lid, the guitar will be in tone in seconds. It doesn't require installing any components, means or devices on the guitar or modifying the guitar. It can either work on an acoustic guitar or electric guitar regardless of the gauge and material of the strings. This invention could be a tuning case to serve a specific guitar, or be a tool to serve a batch of the same model guitars or serve different model guitars with a little adjustment. This invention can also be applied on almost any stringed musical instruments, such as 12 string guitar, bass, banjo, mandolin, violin, cello, harp or even piano etc,

### FIELD OF THE INVENTION

This invention relates to an apparatus for automatic tuning stringed musical instruments.

### BACKGROUND OF THE INVENTION

The following patents describing automatic tuning devices use electromechanical devices to change or maintain pitch.

### US Patent Application 20080006140, Adams, Jan. 10, 2008

“Device and Method for Automatic Tuning of a String Instrument in Particular a Guitar” discloses an automatic tuning devise for a guitar, by recording a tone and output of a corresponding digital signal to a comparator device for comparison of the digital signal with a digital signal corresponding to the desired tone, then adjust the tension of the string accordingly.

### US Patent Application 20070240554, Hany, Oct. 18, 2007,

“Musical tuning switcher” discloses that the invention is an attachable string tension control device for adjusting the pitch of each string of a musical instrument. Allowing an operator to switch instantly between a variety of pre-selected tunings.

### US Patent Application 20070214935, Lyles, Sep. 20, 2007,

“Stringed musical instrument using spring tension” discloses a stringed musical instrument employs springs to apply tension to corresponding musical strings. Each spring is chosen and configured for its ability to impart a string tension generally matched to the appropriate tension of the string at perfect tune.

### US Patent Application 20060037459, Skinn, Feb. 23, 2006

“Apparatus and method for self-tuning stringed musical instruments with an accompanying vibrato mechanism” discloses that an automatic tuning system for a stringed instrument is provided having a string adjustment assembly comprising a motor and gear assembly.
U.S. Pat. No. 6,278,047, Cumberland, Aug. 21, 2001
“Apparatus for tuning stringed instruments” discloses a microprocessor-controlled tuning apparatus for a stringed instrument, wherein the tension of a string is detected by a sensor, compared with a reference value, and readjusted until the detected value conforms with the reference value.
U.S. Pat. No. 5,886,270, Wynn, Mar. 23, 1999
“An electormechanical tuner for stringed instruments” discloses that the invention is an automatic tuning system for a stringed instrument. An input sensor detects the tone of a plucked string and converts it to a square wave of the detected frequency, which is compared by the microprocessor and energizes the solenoid for engaging the gear mechanism for tightening or loosening the string to obtain the required frequency.
U.S. Pat. No. 5,859,378 Freeland, Jan. 12, 1999
“Musical instrument self-tuning system with capo mode” discloses a control system for automatically tuning a stringed musical instrument with a capo installed.
U.S. Pat. No. 5,824,929, Freeland, Oct. 20, 1998
“Musical instrument self-tuning system with calibration library” discloses a control system for automatically utilizing a library of calibration functions to tune a stringed musical instrument in a plurality of operating conditions without recalibration.
U.S. Pat. No. 6,437,226 Oudshoom, et al. (2002)
U.S. Pat. No. 6,184,452 Long (2001)
U.S. Pat. No. 5,886,270 Wynn (1999)
U.S. Pat. No. 5,824,929 Freeland, et al. (1998)
U.S. Pat. No. 5,767,429 Milano, et al. (1998)
U.S. Pat. No. 5,528,970 Zacaroli (1996)
U.S. Pat. No. 5,343,793 Pattie (1994)
U.S. Pat. No. 5,095,797 Zacaroli (1992)
U.S. Pat. No. 4,958,550 Kugimoto (1990)
U.S. Pat. No. 4,803,908 Skinn, et al. (1989)
U.S. Pat. No. 4,584,923 Minnick (1986)
U.S. Pat. No. 4,228,715 Noumey (1980)
U.S. Pat. No. 4,088,052 Hedrick (1978)

These systems or devises are all need to be added on a musical instrument or modify the musical instrument, which could result in the sound of the musical instrument being fundamentally changed.

### SUMMARY OF THE INVENTION

This invention is for automatic, accurate and swift tuning any kind of guitar. It can either work on acoustic guitar or electric guitar regardless of the gauge and material of the strings. It doesn't require modifying the guitar itself. Literally, this invention can also be an apparatus to automatic tune any kind of stringed musical instruments such as basses, banjo, mandolin, violin or piano etc.

### OBJECTS AND ADVANTAGES

This invention can automatically tune a guitar according to a user's selected tuning and temperament. Comparatively, it's faster and more accurate than manually tuning. This invention does not need to modify the guitar itself. Any changing or adding a device on a conventional guitar body will result in the guitar sound fundamentally changed or sense of feeling missing, especially for an acoustic guitar.
To manually and accurately tune a guitar is not easy even with a tuner for help. It could take long time, because changing one string's tension will affect other strings' tension on a guitar. So, you have to tune string by string and over again and again. Whoever, the automatic guitar tuning case tunes all strings synchronically, and ended tuning only when all strings are in tone at the same time.
This invention can either tune electric guitar or acoustic guitar regardless of the gauge and material of the strings.
It's hard to twist some kind of guitar peg, such as classic guitar with nylon strings. It will go out of tone shortly after being tuned. If manually tuning it, you have to tune many times to keep it in tone. However it's easy and fast to tune as many times as you wish with this invention by just pressing a button.
Many guitarists like play open tunings and alternate tunings. In the automatic guitar tuning case, several popular open tunings and alternate tunings are preset in the program. To change tuning you just need to select one of preset buttons, and the guitar will be tuned as you wish.

Here are some most popular tuning patterns:

| | |
|---|---|
| Standard | E A D G B E |
| Open E | E B E G# B E |
| E Flat | Eb Ab Db Gb Bb Eb |
| Open D | D A D F# A D |
| Drop D | D A D G B E |
| DADGAD | D A A G A D |
| Double Drop D | D A D G B D |
| Open G | D G D G B D |
| Double Drop D | D A D G B D |

Also, you can store your favorite tuning patterns other than above preset tuning patterns in the tuning system.

This invention could be a tuning case to serve a specific guitar, or be a tool to serve a batch of the same model guitars or serve different model guitar with a little adjustment.

It's easy to check if a guitar in tone or not with the automatic guitar tuning case because all strings' pitch statues will be displayed on the LED array.

This invention is portable with a rechargeable battery and literally it can work in anywhere.

If want to keep a guitar in no tension, the system can loose all strings without blinking an eye. Next time, if want to play it again, just need to press a button and the guitar will be in tone in seconds.

The automatic guitar tuning case can be both a tuning tool and a carrying case.

This invention has a bonus of safety feature. If tuning by hand, usually, hands and eyes are closely exposure to the strings. Broken string might hurt hands or in extreme case hurt your eye by accident. With this invention, such kind of incident would never happen because tuning guitar is always under cover.

### BRIEF DESCRIPTION OF THE DRAWINGS

FIG. 1 is a perspective view of the automatic guitar tuning case.

FIG. 2 is a top view of control penal and control penal lid with neck bass.

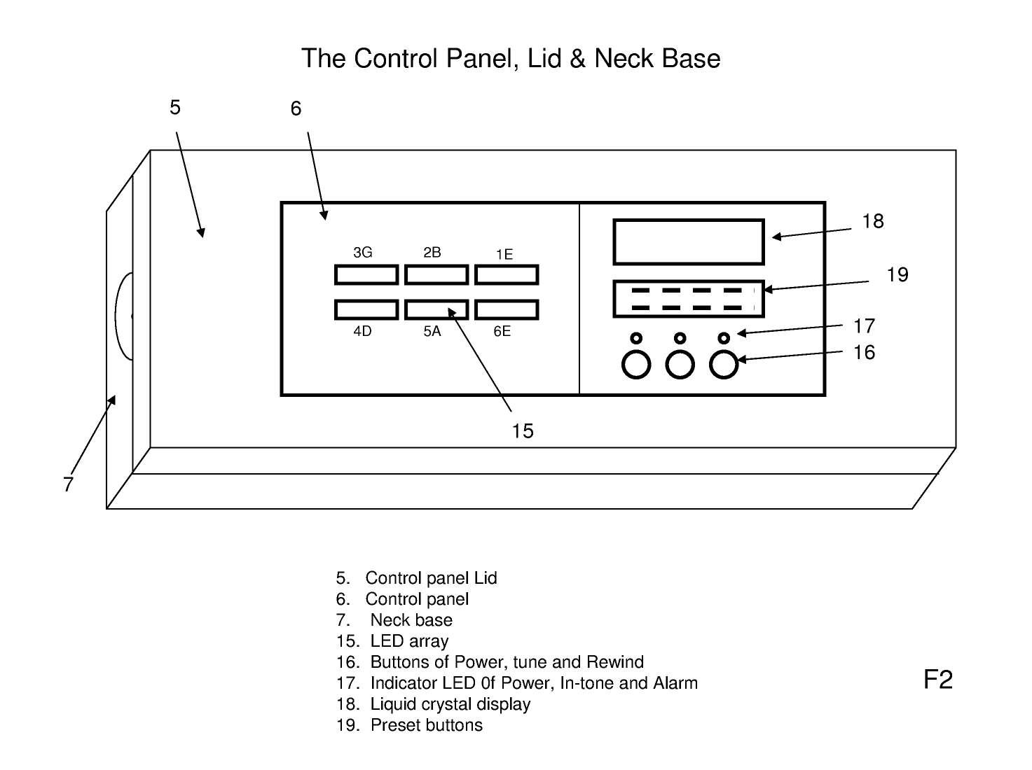

FIG. 3 is a perspective view of a Transducer array unit.

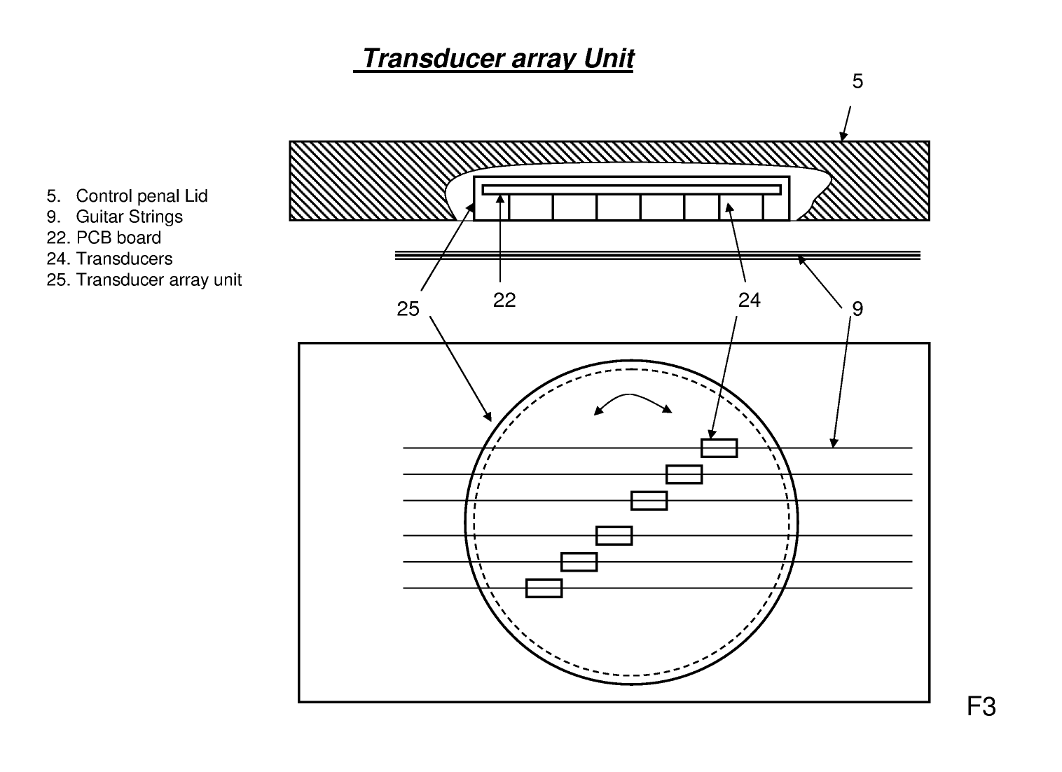

FIG. 4 is a front view of a strum unit.

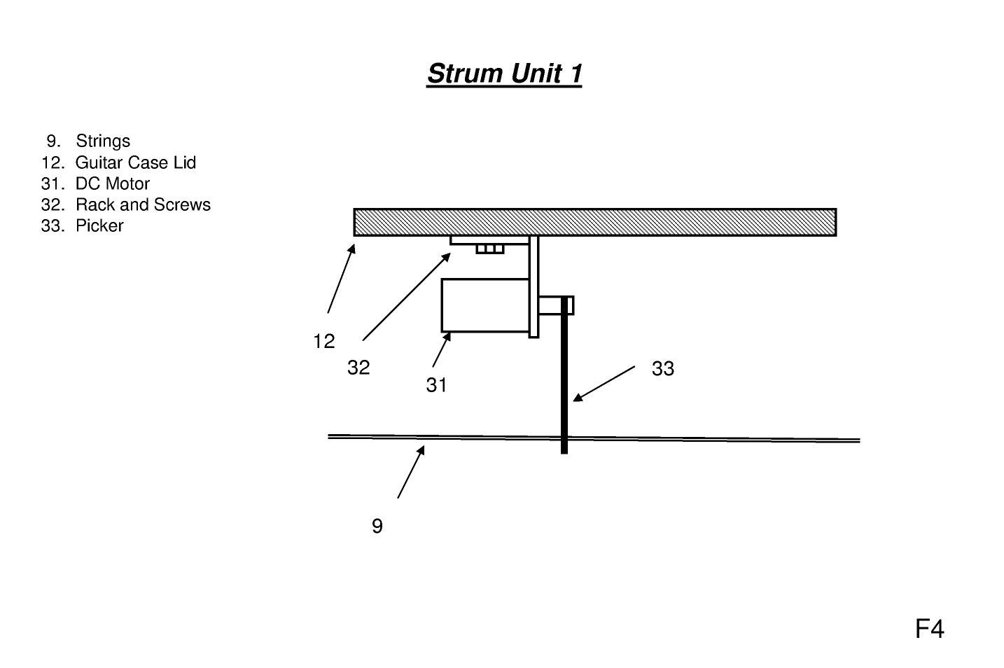

FIG. 5 is a perspective view of an Electric Tuning Wrench.

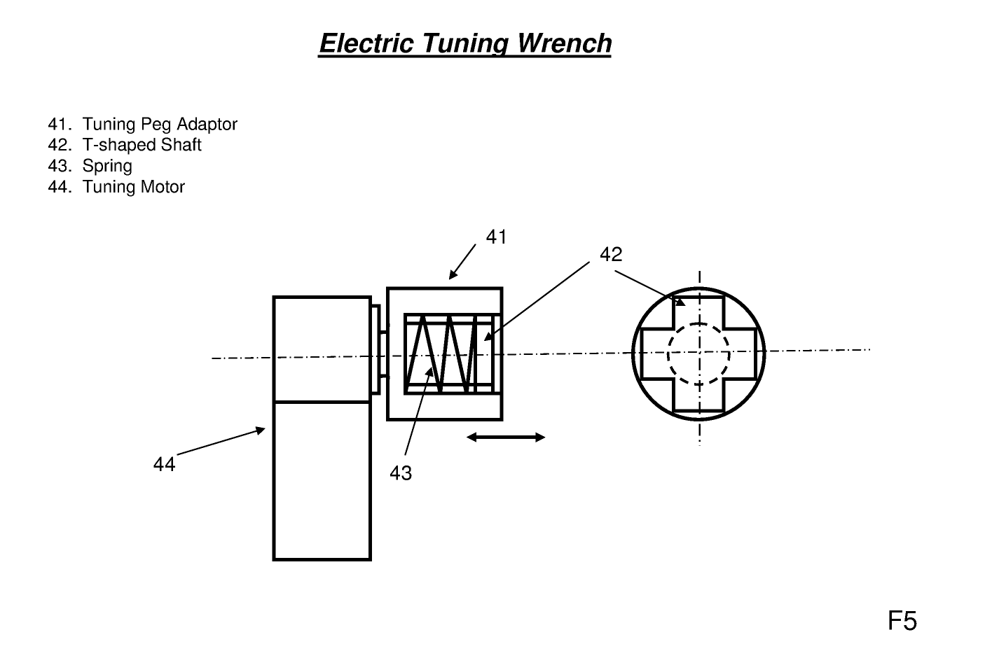

FIG. 6 is a perspective view of Parts of Tuning Wrench.

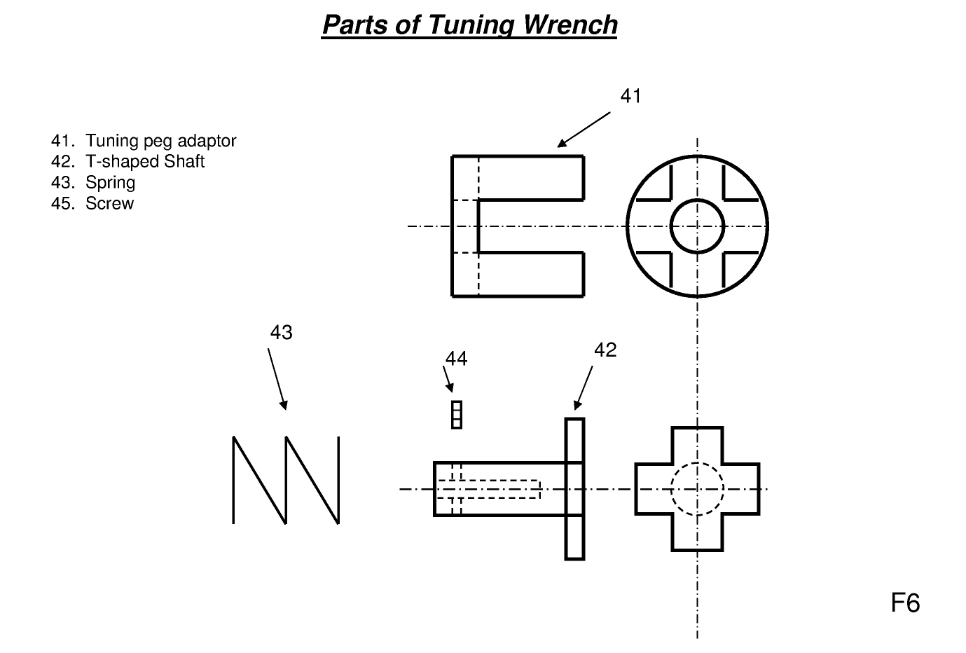

FIG. 7 is a front view of a Mechanical Tuning Unit.

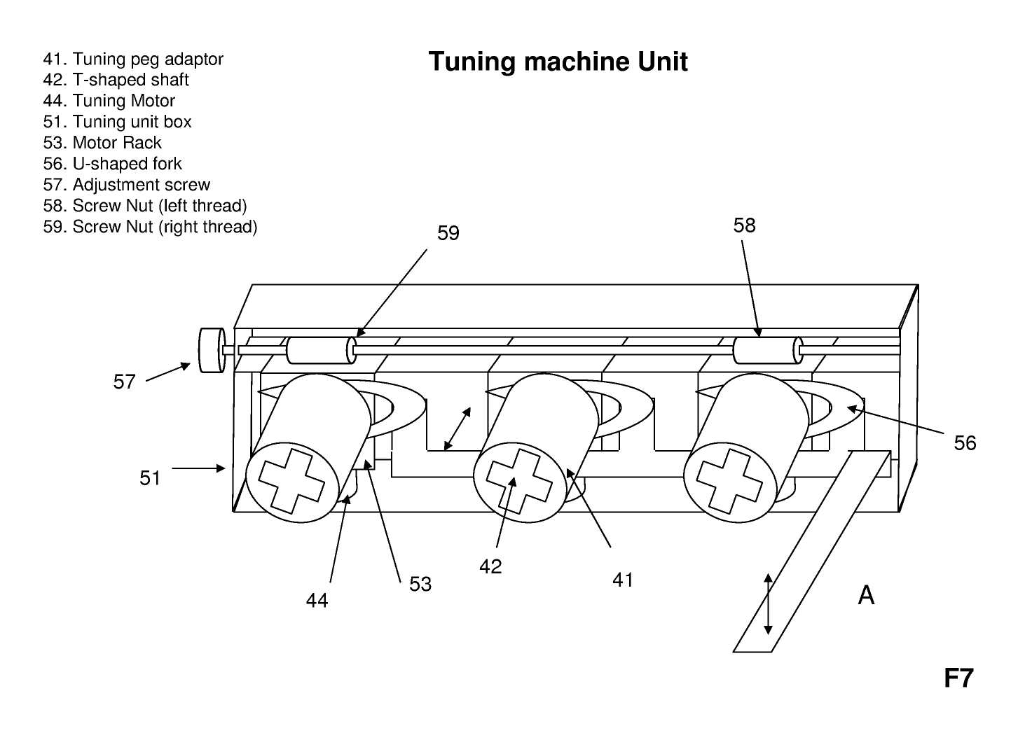

FIG. 8 is a view of an opened Control Penal Lid with Neck Base.

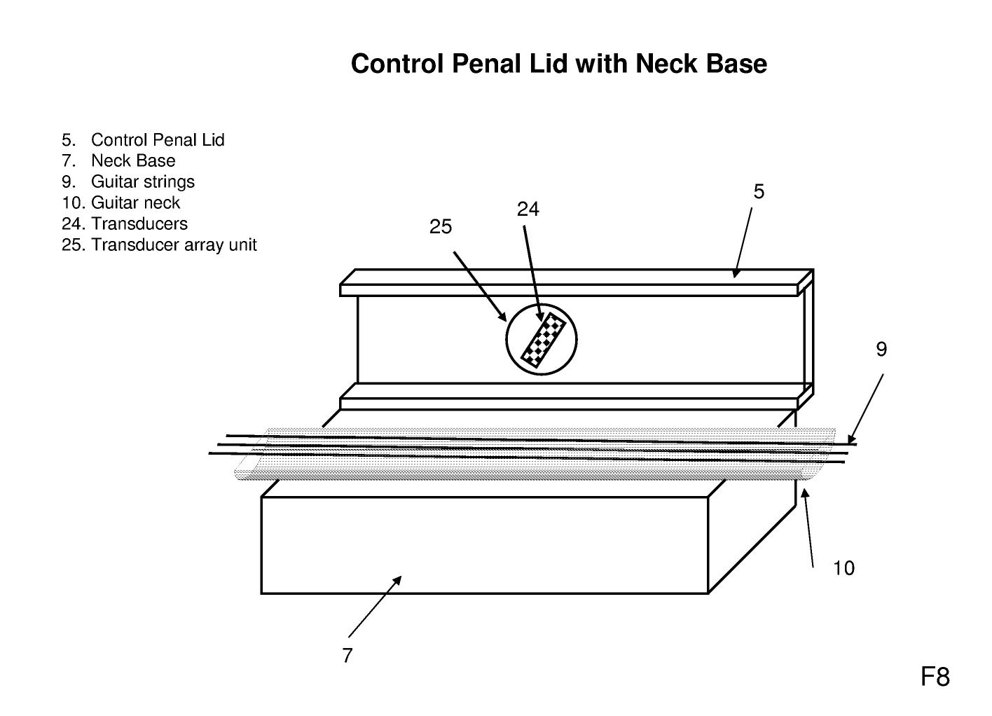

FIG. 9 is a view of a neck support.

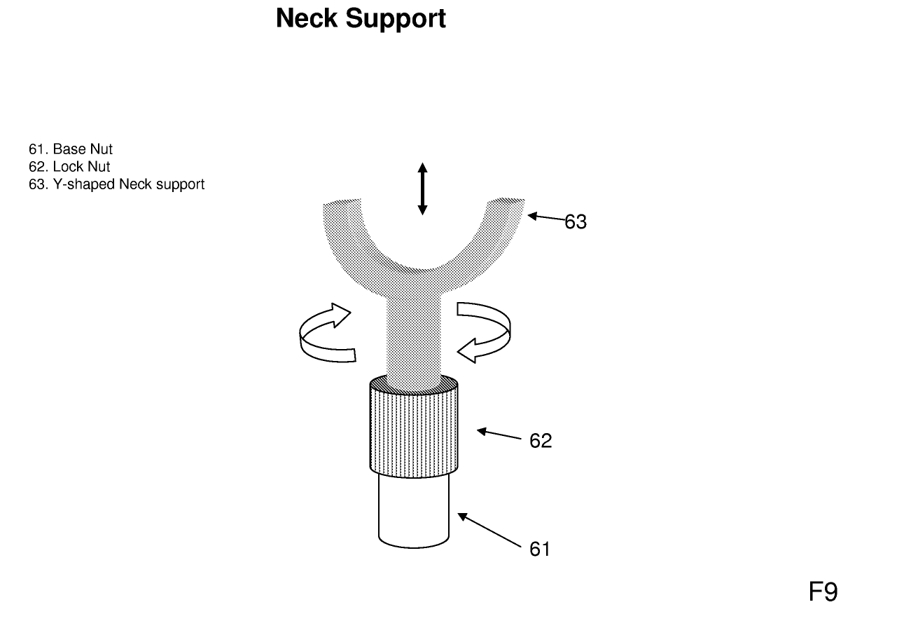

FIG. 10 is a perspective view of an Adjustable Strap Pin Support.

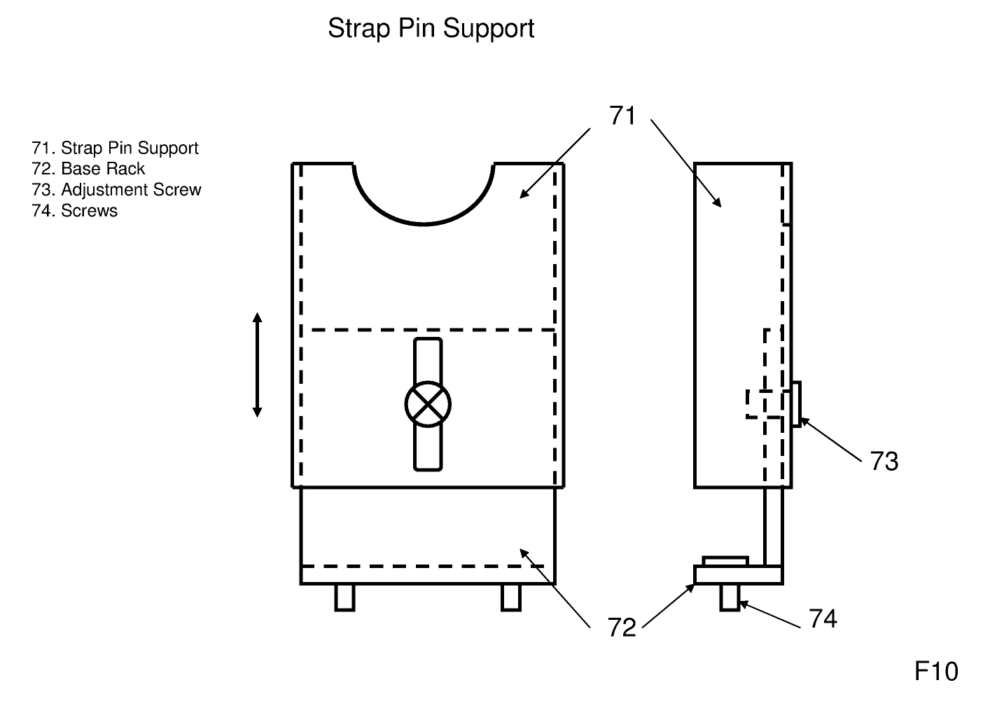

FIG. 11 is a schematic block diagram showing Microprocessor Unit.

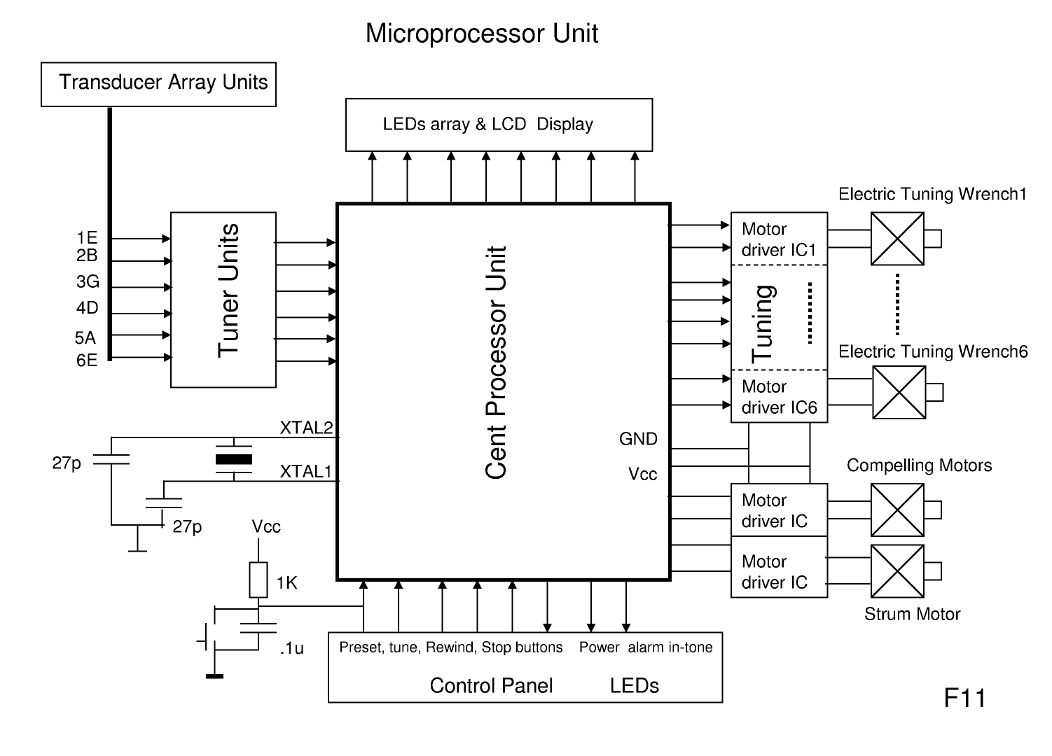

FIG. 12 is a block diagram showing a tuner unit.

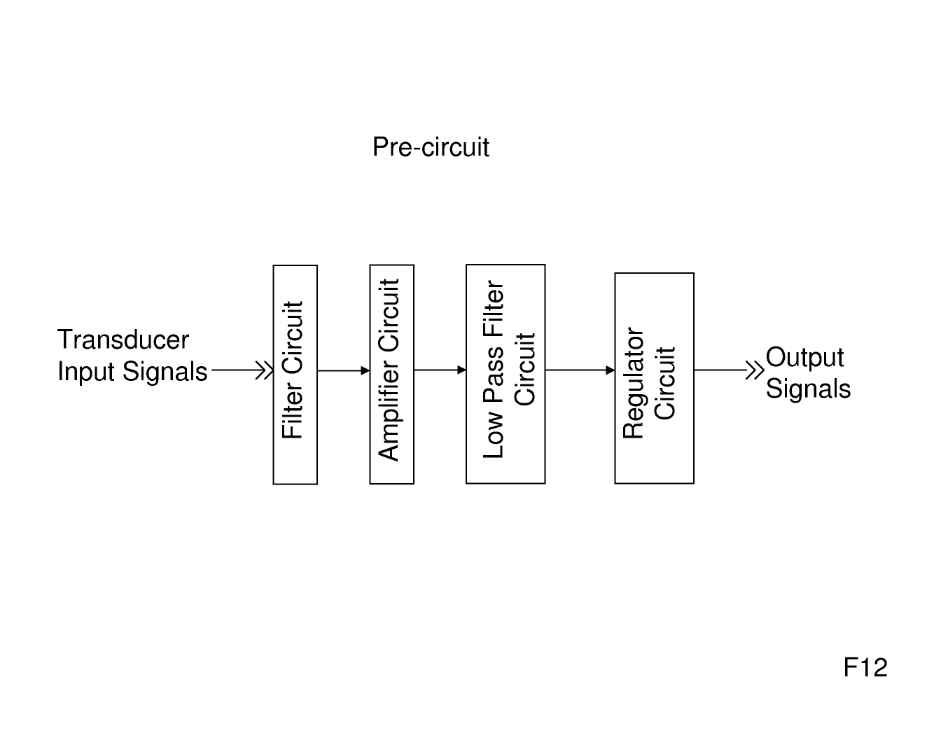

FIG. 13 is a block diagram showing a tuning process.

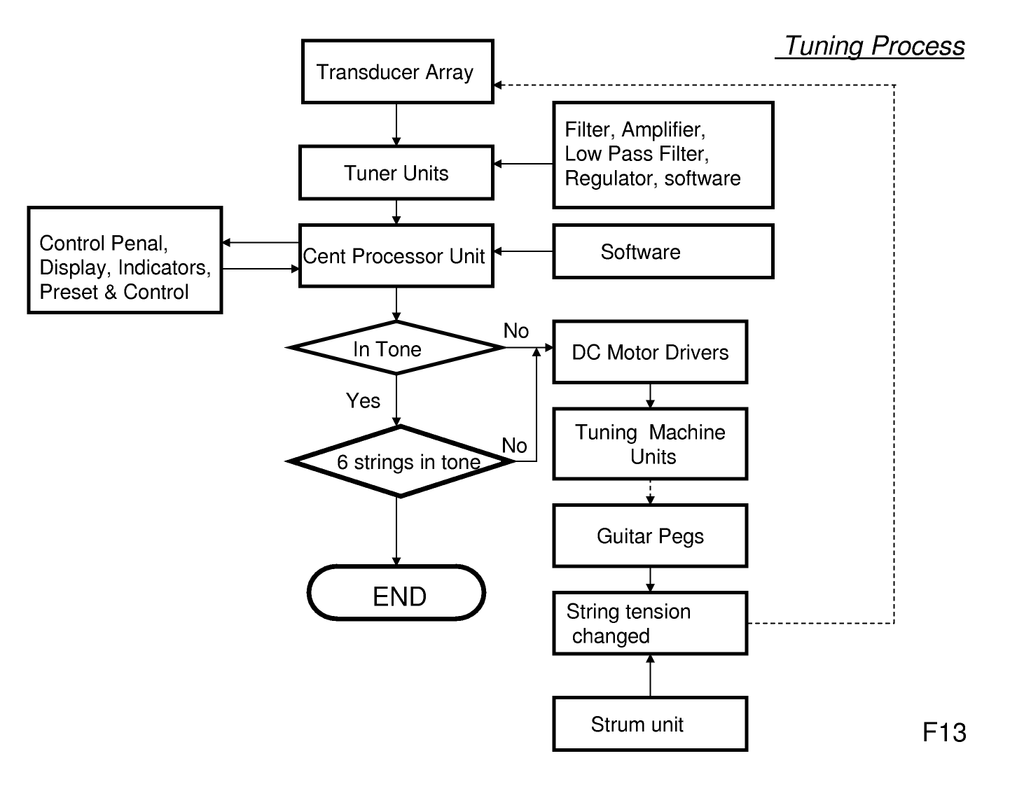

### DETAILED DESCRIPTION OF THE DRAWINGS

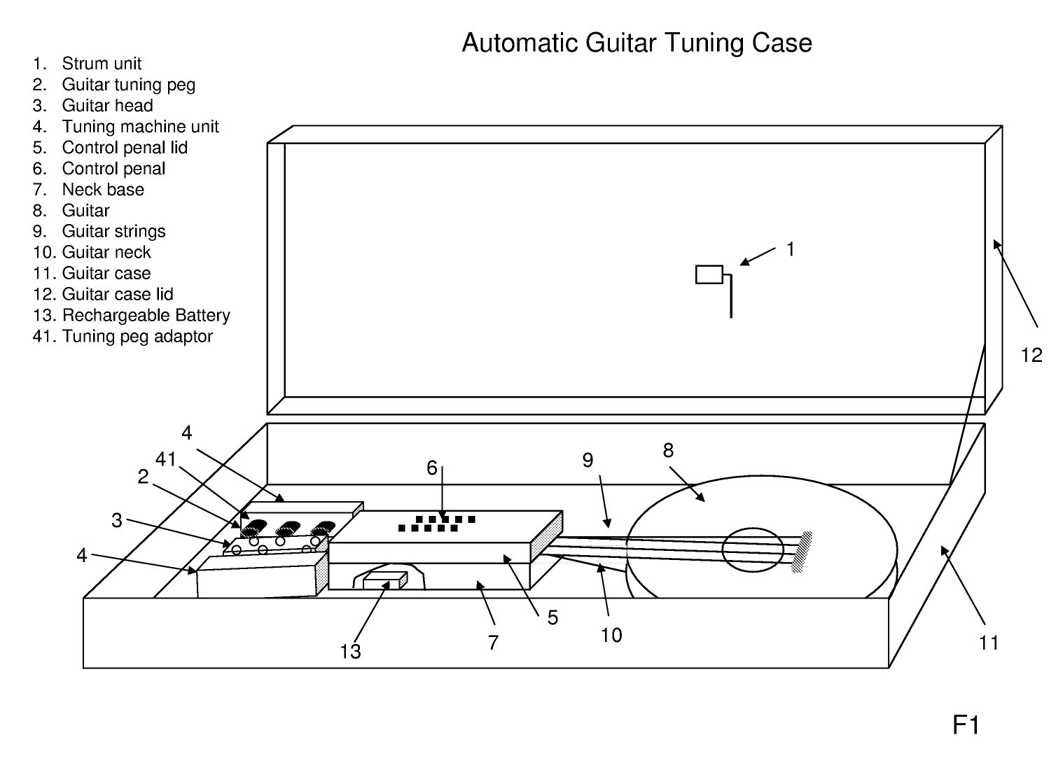

F1 shows the main units of the automatic guitar tuning case. In FIG. 1, there are two tuning machine units 4 are set on two sides of a guitar head 3. The tuner units and center processor unit are all in the control penal lid 5. The control penal 6 is on the top of control penal lid 5. A rechargeable battery 13 is sat in the neck base 7. A strum unit 1 is mounted on the lid of an automatic guitar tuning case 12.

F2 Shows a Control Panel 6 on a Control Panel Lid 5. On the control penal 6, there are LED Arrays 15 for showing all strings' pitch statues, a LCD (liquid crystal display) 18 for showing a selected tuning and temperament, LEDs 17 for being indicators of power-on, alarm and in-tone, some preset buttons 19, and some control 16 of tune, rewind and switch on/off.

F3 shows a transducer array unit 25 which consists of six transducers 24 soldered on a PCB 22. The transducer array unit 25 is installed on backside of the Control Penal 6. It could rotate a little bit for adjustment to match different wideness of guitar fingerboard and make the six transducers 24 exactly and respectively ride over the six strings 9.

F4 shows the structure of a strum device 1. A DC motor 31 is installed on a rack 32 which is mounted on the guitar case lid 12. The strum picker 33 is attached on the motor axis, so when the DC motor 31 tuning the strum picker 33 will pluck the string 9 at one direction.

F5 shows an electric tuning wrench. The tuning wrench droved by a tuning motor 44. The tuning wrench mainly consists of a tuning peg adaptor 41, a T-shaped shaft 42 and a Spring 43. When the tuning peg adaptor 41 is pushed forward to a guitar peg, if the peg doesn't match into a slot of the tuning peg adaptor 41, the tuning peg adaptor 41 will squeeze against on the guitar peg. Meanwhile, the tuning motor 44 drives the tuning wrench until a slot of the tuning peg adaptor 41 matches the guitar peg to let the tuning wrench clutches the guitar peg. Then, the electric tuning wrench is able to drive a guitar peg in two directions for tightening or loosening the string. If the pushing force released on the tuning peg adaptor 41, the spring 43 will force the tuning peg adaptor 41 back to the initial position from the guitar peg, therefore the tuning wrench will disconnect with the guitar peg.

F6 shows the parts of tuning wrench. On a tuning peg adaptor 41 there are two cross slots which can accommodate most convention guitar pegs. In the cent of the tuning peg adaptor 41 there is a hole to let a T-shaped shaft 42 insert in. The tuning peg adaptor 41 can slide along the T-shaped shaft 42 but turning together. A spring 43 sits between them. T-shaped shaft 42 and tuning motor axis are coupled by a screw 45.

F7 shows the details of mechanical tuning unit. The tuning motors 44 are installed on motor racks 53. To match the interval of different guitar pegs, the interval of the tuning wrenches can be adjusted by turning the adjustment screw 57 because the middle tuning wrench is fixed and two sides of tuning wrenches are with opposite thread nut 58 (left thread) and nut 59 (right thread). So, tuning the adjustment screw 57 can change the interval of the electric tuning wrenches.

Pushing down at the point “A” of U-shaped fork 56 will make the U-shaped fork 56 push the tuning peg adaptor 41 forward to a guitar peg. The pushing force can be made by closing a lid or by a compelling motor instead. All parts are contained within a tuning unit box 51.

F8 shows an opened control penal lid and neck base. The transducer array unit 25 is installed on the backside of control penal 6. The control penal lid 5 hinges with a neck base 7 which supports a guitar neck 10. If close the control penal lid 5, six transducers 24 will exactly and respectively ride over six guitar strings 9 after initial adjustment.

The whole tuning system can work without the guitar case. It could work by laid on a table, hanged on wall or installed on a guitar stand. After putting a guitar on the neck base, closing the control penal lid to start a tuning program and manually plucking the strings, the guitar will be tuned in tone automatically.

### ALTERNATE EMBODIMENT

If taking off the control penal lid 5 from the neck bass 7 and install it on the guitar case lid 12, then, when closing the guitar case lid 12, the strum unit 1 will pluck the strings to make the strings vibrate and the transducers will pickup the vibrate signal to perform totally automatic tuning a guitar.

In some cases, the neck base 7 could be replaced by a neck support as showed on F9. A Y-shaped neck support 63 screwed into a base nut 61 with a lock nut 62. The base nut is installed on the bottom of a guitar case 11. So, the height of neck support is adjustable and also the Y-shaped neck support 63 can be turned a little bit to accommodate different wideness of guitar necks. After adjustment, the Y-shaped neck support 63 can be locked by tightening the lock nut 62.

Also it may need a strap pin support as showed on F10. It comprises a strap support 71 and a base rack 72. They are connected by an adjustment screw 73. The Strap Pin Support is installed on the bottom of a guitar case 11 to hold the end strap pin of guitar. So, the guitar body position can be adjusted by strap pin support.

F11 shows a block diagram of Processors. A center processor unit receives signals from tuner units and user order from a control panel. It outputs control signals to motor driver ICs, compelling motor driver ICs to drive all motors. Meanwhile, provides display signals to a control penal for showing all strings' pitch status on LED array and selected tuning and temperament on LCD.

F12 shows a flow diagram of Tuner Unit. The signals from transducers pass through a Filter circuit, Amplifier circuit, Low Pass Filter, Regulator circuit and finally to a tuner processor, which will produce a result of the string's pitch comparing with a selected tuning.

F13 shows the program flow diagram of whole tuning process. The automatic guitar tuning case is a closed-loop control system. A strum unit plucks the six strings on a guitar and six transducers respectively convert these vibrating strings to electric signals, which provide to six tuner units to analyze these strings' tones. A center processor unit will control six electric tuning wrenches to tune the six guitar strings according to the results from the six tuner units and a selected tuning by a user operating on the control penal. The tuning process will end only when all six strings in tone at the same time.

### LIST NO. OF COMPONENTS, PARTS AND UNITS

1. Strum Unit
2. Guitar tuning Pegs
3. Guitar head
4. Tuning machine unit
5. Control Penal Lid
6. Control penal
7. Neck Base
8. Guitar
9. Guitar strings
10. Guitar neck
11. Guitar case
12. Guitar case lid
13. Rechargeable Battery
14. LED Array
15. Buttons of preset, tune and Rewind
17. Indicator LED of Power-on, In-tone and Alarm
18. LCD (Liquid Crystal Display)
22. PCB board
24. Transducers
25. Transducer array unit
31. DC Motor
32. Rack and Screws
33. Picker
41. Tuning peg adaptor
42. T-shaped Shaft
43. Spring
44. Tuning Motor
45. Screw
51. Tuning unit box
53. Motor Rack
56. U-shaped fork
57. Adjustment screw
58. Screw Nut (left thread)
59. Screw Nut (right thread)
61. Base Nut
62. Lock Nut
63. Y-shaped Neck support
71. Strap Pin Support
72. Base Rack
73. Adjustment Screw
74. Screws

1. an automatic guitar tuning case comprises:
(1) an automatic strum device for plucking strings to make all strings mechanical vibration on a guitar,
(2) six transducers respectively riding over six strings on a guitar to independently convert said mechanical vibration of the guitar strings to electric signals,
(3) six tuner units which further comprises six pre-circuit units and six tuning processor units,
(4) a center processor unit for preset tunings, display, data process and control of the tuning system,
(5) a tuning processor software which further consists of a signal wave analyzer, signal frequency counter, frequency comparator and a tone database,
(6) a center processor software which consists of a tuning program, a loosening string program, a preset program and a display program,
(7) tuning machine units which further consist of six electric tuning wrenches with racks, U-shaped forks with a compelling device contained in one or two housing boxes,
(8) a control penal which further consists of a LCD for showing selected tuning and temperament, LED array for indicating all strings' pitch status, LEDs as indicators of Power-on, In-tone and Alarm, preset buttons for selecting tunings, and control buttons of Tune, Rewind and On/Off switch etc.,
(9) a power supply and a rechargeable battery for supplying energy to said tuning system,
(10) a neck base or neck support which holds on a guitar neck to make it in immovable proper position.
(11) a strap pin support which holds on a guitar body to it in immovable proper position.
(12) a case for housing a guitar and a said tuning system which includes all above components, parts, means, devices and software,

2. The automatic guitar tuning case of claim 1, wherein said strum device further comprises a dc motor, a strum picker attached on the spin axe of said dc motor with a rack which is mounted on the lid of said automatic guitar tuning case,

3. The automatic guitar tuning case of claim 1, wherein said transducers can either be electromagnetic, optical or piezoelectric pickups which must be able to independently detect and convert the mechanical vibration of their associated guitar strings to electric signals without signal bleed or affect each other,

4. The automatic guitar tuning case of claim 1, wherein said pre-circuit unit further consists of a filter circuit, amplifier circuit, low pass filter circuit and regulator circuit etc.,

5. The automatic guitar tuning case of claim 1, wherein said electric signal from said transducer will forward through said filter circuit, amplifier circuit, low pass filter and regulator circuit to be a regulated signal,

6. The automatic guitar tuning case of claim 5, wherein said regulated signal will be converted to a digital signal within said tuning processor unit,

7. The automatic guitar tuning case of claim 1, wherein said signal wave analyzer is for checking the input signal to see if the signal is in a normal scope called as a good sample,

8. The automatic guitar tuning case of claim 1, wherein said signal frequency counter is for counting the frequency of said good sample,

9. The automatic guitar tuning case of claim 1, wherein said frequency comparator is for comparing the frequency of said good sample with a frequency of selected tuning pattern to check if it is higher, lower or equal,

10. The automatic guitar tuning case of claim 1, wherein said tuning program in center processor unit performs collecting the result of compared frequency from said tuner unit, outputting control signals to said dc motor driver units, and ending said tuning program when all six guitar strings are all in tone at the same time, or stopping said tuning program with blinking and buzzing when an error occurred,

11. The automatic guitar tuning case of claim 1, wherein said preset program is for quick changing tuning among popular preset tuning patterns which are standard tuning, open tunings, alternate tunings and user stored tunings by pressing one of preset buttons,

12. The automatic guitar tuning case of claim 1, wherein said popular preset tunings are Standard, Open E, E Flat, Open D, Drop D, Double Drop D, Open G etc.,

13. The automatic guitar tuning case of claim 1, wherein said dc motor driver unit is an array of dc motor driver ICs for driving said electric tuning wrenches which can turn in two directions for tightening or loosening guitar strings.

14. The automatic guitar tuning case of claim 13, wherein said dc motor driver IC also drives said compelling motor for compelling said U-shaped forks to push said tuning peg adaptors forward to guitar pegs,

15. The automatic guitar tuning case of claim 13, wherein said dc motor driver IC also drives said strum motor,

16. The automatic guitar tuning case of claim 1, wherein said electric tuning wrench further consists of a tuning motor and a tuning wrench which is attached on the spin axe of said tuning motor,

17. The automatic guitar tuning case of claim 16, wherein said tuning wrench further consists of a tuning peg adaptor in which there is a center hole and two slots, a T-shaped shaft which inserts into said center hole, a spring setting between said tuning peg adaptor and said T-shaped shaft for restoring said tuning peg adaptor back to initial position from guitar peg when compelling force withdraw,

18. The automatic guitar tuning case of claim 1, wherein said tuning motors are installed on individual motor racks,

19. The automatic guitar tuning case of claim 18, wherein said motor racks are movable and adjustable installed on an adjustment screw in said housing box for adjusting the intervals of said electric tuning wrenches to match different intervals of guitar pegs,

20. The automatic guitar tuning case of claim 1, wherein said U-shaped forks are made of a piece of elastic metal for squeezing said tuning peg adaptor against on a guitar peg if the slot of said tuning peg adaptor didn't fit onto the tuning peg until said tuning peg adaptor clutches the guitar peg by driving said tuning wrench,

21. The automatic guitar tuning case of claim 1, wherein said compelling device can be droved by said compelling motor or by control penal lid or guitar case lid instead,

22. The automatic guitar tuning case of claim 1, wherein said tuning system could work alone without the guitar case,

23. The automatic guitar tuning case of claim 1, wherein said tuning system could be laid down on a table, hanged on wall or installed on a guitar rack to tune a guitar,

24. The automatic guitar tuning case of claim 23, wherein said tuning system would work by manually plucking the guitar strings,

25. The automatic guitar tuning case of claim 1, wherein said tuning system can be applied on any stringed musical instruments, such as 12 string guitar, bass, banjo, mandolin, violin, cello, harp and piano etc,
